(19) United States
(12) Patent Application Publication
(10) Pub. No.: US 2012/0090590 A1
(43) Pub. Date: Apr. 19, 2012

(54) INDUCER FAN ASSEMBLY FOR A GAS FURNACE SYSTEM

(75) Inventors: Larry D. Rieke, Zionsville, IN (US); Scott A. Beck, Indianapolis, IN (US); ChiaYee Ang, Avon, IN (US)

(73) Assignee: CARRIER CORPORATION, Farmington, CT (US)

(21) Appl. No.: 13/237,522

(22) Filed: Sep. 20, 2011

Related U.S. Application Data
(60) Provisional application No. 61/393,480, filed on Oct. 15, 2010.

(51) Int. Cl. F24H 3/06; F24H 9/16; F16L 43/00; F04D 29/52

(52) U.S. Cl. 126/110 R; 417/423.14; 126/116 R; 285/179

(57) ABSTRACT

An inducer fan assembly including an inducer fan housing having a flue vent connection member configured and disposed to be connected to an exhaust gas flue vent. The flue vent connection member includes a flue gas outlet and a flue vent condensate inlet.

### CROSS REFERENCE TO RELATED APPLICATION

This application is a Non-Provisional Application of U.S. Provisional Application Ser. No. 61/393,480 filed Oct. 15, 2010.

### BACKGROUND OF THE INVENTION

Exemplary embodiments pertain to the art of gas furnace systems and, more particularly, to an inducer fan assembly for a gas furnace system.

Gas furnace systems burn a gas fuel to generate heat. Exhaust gases generated by burning the fuel are passed through a chimney or flue and discharged to, in most cases, ambient. In the flue, the exhaust gases cool and form a liquid condensate. It is desirable to remove the liquid condensate from the flue in order to minimize flue blockage, diminished inducer fan performance, diminished performance of other furnace components, and/or rusting and other corrosion effects on portions of the gas furnace system. Condensate flowing back from the flue passes back towards and inducer fan housing. The condensate is collected with a pipe tee or drain channels formed in a housing of the inducer fan. The condensate is then passed through elastomeric piping to a condensate trap or drain.

### BRIEF DESCRIPTION OF THE INVENTION

Disclosed is an inducer fan assembly including an inducer fan housing having a flue vent connection member configured and disposed to be connected to an exhaust gas flue vent. The flue vent connection member includes a flue gas outlet and a flue vent condensate inlet.

Also disclosed is a pipe elbow including an inlet member having an inlet member centerline, and an outlet member having an outlet member centerline. The inlet member centerline is off-set from the outlet member centerline.

Still further disclosed is a gas furnace system including a heat exchanger, and an inducer fan assembly mounted to the heat exchanger. The inducer fan assembly includes an inducer fan housing having a flue vent connection member configured and disposed to be connected to an exhaust gas flue vent. The flue vent connection member includes a flue gas outlet and a flue vent condensate inlet. A pipe elbow is mounted to the flue vent connection member. The pipe elbow includes an inlet member having an inlet member centerline, and an outlet member having an outlet member centerline. The inlet member centerline is off-set from the outlet member centerline.

### BRIEF DESCRIPTION OF THE DRAWINGS

The following descriptions should not be considered limiting in any way. With reference to the accompanying drawings, like elements are numbered alike:

FIG. 1 is a left perspective view of a gas furnace system including an inducer fan assembly and collector box in accordance with an exemplary embodiment;

FIG. 2 is a perspective view of the inducer fan assembly and collector box of FIG. 1;

FIG. 3 is a perspective view of a pipe elbow that is configured to be connected to the inducer fan assembly of FIG. 2;

FIG. 4 is top view of the pipe elbow of FIG. 3; and

FIG. 5 a front view of the pipe elbow of FIG. 3.

### DETAILED DESCRIPTION OF THE INVENTION

A detailed description of one or more embodiments of the disclosed apparatus and method are presented herein by way of exemplification and not limitation with reference to the Figures.

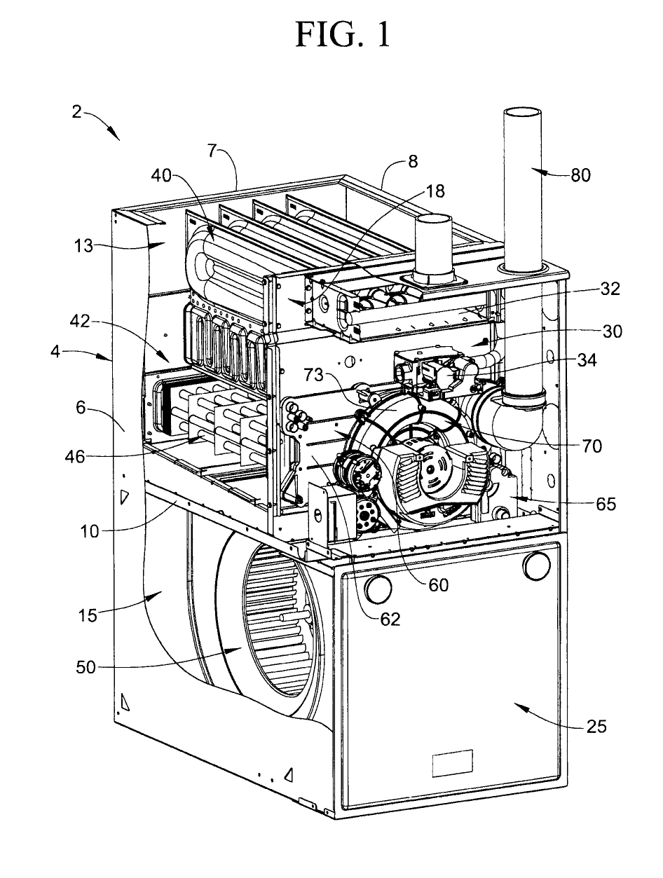

With reference to FIG. 1, a gas furnace system in accordance with an exemplary embodiment is indicated generally at 2. Gas furnace system 2 includes a housing 4 having a plurality of exterior walls 6-8 and an interior dividing wall 10 that forms a heat exchange portion 13 and a blower portion 15. Heat exchange portion 13 includes a component support wall 18 which, as will be discussed more fully below, provides structure for mounting various components of gas furnace system 2. Housing 4 is also shown to include an access panel 25 that provides access to blower portion 15 and another access panel (not shown) that provides access to heat exchange portion 13.

Gas furnace system 2 is also shown to include a burner assembly 30 mounted to component support wall 18. Burner assembly 30 includes a burner box 32 and a gas valve 34. Burner assembly 30 combusts a fuel, in the form of gas to generate heat used to condition a comfort zone such as living spaces, work spaces and the like. As will be discussed more fully below, products of combustion or exhaust gases generated by the burning of the fuel are expelled to ambient. In the Exemplary embodiment shown, burner assembly 30 is operatively connected to a primary heat exchanger 40 arranged within heat exchange portion 13. Primary heat exchanger 40 is operatively coupled to a condensing heat exchanger 42. Condensing heat exchanger 42 includes a plurality of heat exchange members 46. With this arrangement, a blower motor assembly 50 arranged within blower portion 15 draws in air from a space to be heated. The air is guided over primary heat exchanger 40, and heat exchange members 46 of condensing heat exchanger 42. The air is heated and then re-introduced into the space.

During operation of gas furnace system 2, moisture from the products of combustion condenses in condensing heat exchanger 42. This moisture collected and then passed to an external drain (not shown). The moisture is guided to a condensate collector box 60. Condensate collector box 60 includes a first surface 62 and a second surface (not separately labeled) that is secured to component support wall 18. The moisture is collected in condensate collector box 60, passed to a condensate trap 65, and on to the external drain. In accordance with the exemplary embodiment shown, an inducer fan assembly 70 is mounted to first surface 62 of condensate collection box 60. Inducer fan assembly 70 creates an air flow that establishes a draft which draws the products of combustion from burner box 32 as will be discussed more fully below. More specifically, inducer fan assembly 70 produces a pressure rise and flow rate to achieve a desired combustion performance while overcoming flow losses within gas furnace system 2.

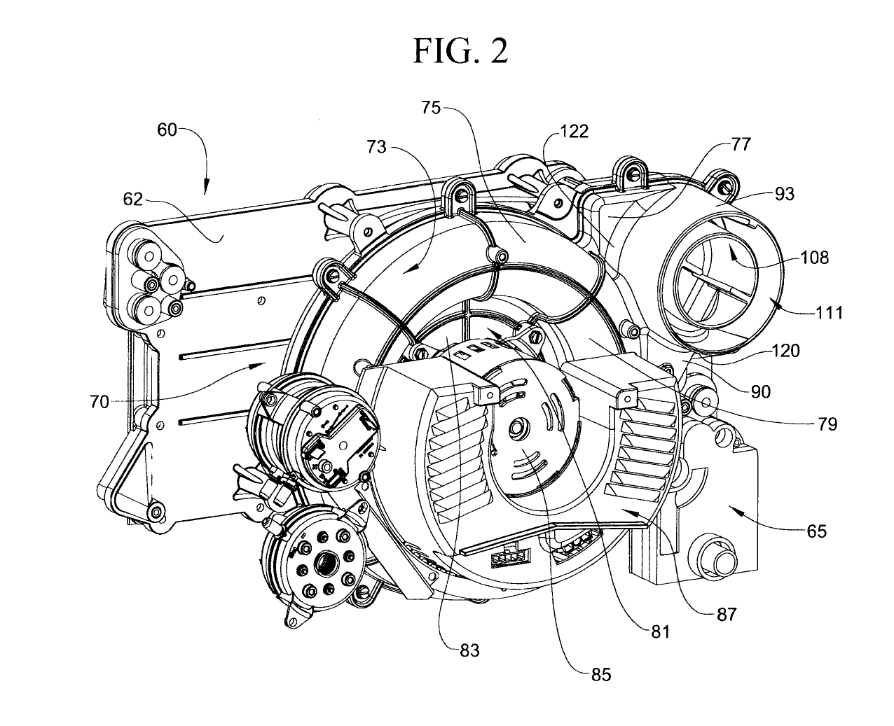

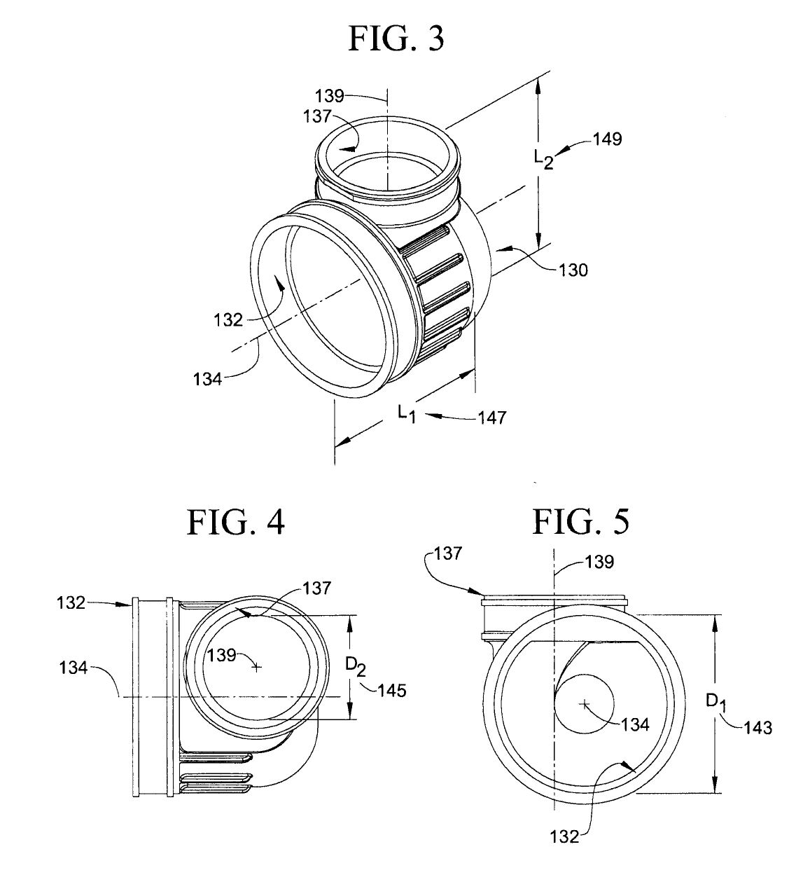

As best shown in FIG. 2, inducer fan assembly 70 includes an inducer fan housing 73 includes a fan portion 75 and a flue vent connecting portion 77 that is operatively connected to a flue vent 80. Fan portion 75 includes an annular flow guide 79 that defines a recessed region 81 having a motor support surface 83. A motor 85 is secured to motor support surface 83 and operatively connected to a rotor fan (not shown) arranged within inducer fan housing 73. Motor 85 defines an axis of rotation for a rotor fan (not shown). In the exemplary embodiment shown, motor 85 is operatively connected to a motor control 87 that establishes a desired operational speed for the rotor fan. Fan portion 75 is fluidly connected to flue vent connecting portion 77 via a discharge passage 90.

As further shown in FIG. 2, flue vent connecting portion 77 includes a flue vent connecting member 93 that extends outward from inducer fan housing 73 parallel to the axis of rotation of the rotor fan. Flue vent connecting member 93 includes a flue gas outlet 108 and a flue vent condensate inlet 111. In accordance with the exemplary embodiment, flue gas outlet 108 is arranged concentrically inward from flue vent condensate inlet. 111. With this arrangement, flue vent connecting portion 77 provides passage for exhaust or flue gases from burner box 32 and also includes a collection zone 120 that receives condensate that may form in flue vent 80. In other orientations, a collection 122 is established. Although shown arranged concentrically, other arrangements, including eccentric arrangements may also be included.

In further accordance with the exemplary embodiment, flue vent discharge portion 77 is coupled to flue vent 80 through a pipe elbow 130. Pipe elbow 130 is a short radius ninety-degree (90°) pipe elbow having a center to end distance that is less than or equal to the nominal pipe size (NPS) as will be discussed more fully below. Pipe elbow 130 includes an inlet member 132 having an inlet member centerline 134 and an outlet member 137 having an outlet member centerline 139. Inlet member centerline 134 is off-set from outlet member centerline 139. By arranging the inlet member centerline 134 off-set a desired amount from outlet member centerline 139, outlet member 137 and flue vent 80 can be located so as to not interfere with other portions of gas furnace system 2. For example, in an upflow orientation, outlet 137 and flue vent 80 are off-set relative to centerline 134. In this manner, flue vent 80 does not interfere with burner assembly 30. Thus, pipe elbow 130 extends only a short distance from flue vent discharge portion 77. In addition, inlet member 132 is formed having a first diameter 143 and outlet member 137 is formed having a second diameter 145. In the exemplary embodiment shown, first diameter 143 is greater than second diameter 145 however it should be understood that first and second diameters 143 and 145 could be substantially similar. Pipe elbow 130 is further shown to include a first length 147 that established a distance from inlet member 132 to a rear portion of the 90° bend, and a second length 149 that establishes a distance from outlet member 137 to the back of the 90° bend. In accordance with one aspect of the exemplary embodiment, first length 147 is equal to second length 149. In accordance with another embodiment, first length 147 is shorter than second length 149 to further ensure that pipe elbow 130 extends only a short distance from flue vent discharge portion 77.

At this point it should be understood that the exemplary embodiments provides a gas furnace system having an inducer fan assembly that includes a fan housing provided with a concentric discharge that extends axially outward. The concentric discharge allows for the release of flue gases and collection of flue gas condensate while maintaining a compact form factor. The compact form factor also provides installation flexibility for a multi-poise furnace. The incorporation of the pipe elbow in combination with the axially extending discharge enables the flue vent to be routed in a variety of configurations depending upon desired installation orientation. Moreover, the exemplary embodiments enable easy modification in the field to change the gas furnace system from an initial configuration to a desired configuration without the need for substantial reconstruction.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the claims.

What is claimed is:

1. An inducer fan assembly comprising:
an inducer fan housing having a flue vent connection member configured and disposed to be connected to an exhaust gas flue vent, the flue vent connection member including a flue gas outlet and a flue vent condensate inlet.

2. The inducer fan assembly according to claim 1, wherein the flue vent connection member extends axially outward from the inducer fan housing.

3. The inducer fan assembly according to claim 1, wherein the flue gas outlet is arranged concentrically relative to the flue vent condensate inlet.

4. The inducer fan assembly according to claim 3, wherein the flue gas outlet is arranged concentrically inward from the flue vent condensate inlet.

5. The inducer fan assembly according to claim 1, further comprising: a pipe elbow fluidly connected to the flue vent connection member, the pipe elbow including an inlet member having an inlet member centerline and an outlet member having an outlet member centerline, the inlet member centerline being off-set from the outlet member centerline.

6. The inducer fan assembly according to claim 5, wherein the inlet member of the pipe elbow includes a first diameter and the outlet member of the pipe elbow includes a second diameter.

7. The inducer fan assembly according to claim 6, wherein the first diameter is distinct from the second diameter.

8. The inducer fan assembly according to claim 6, wherein the pipe elbow includes a first length and a second length, the first length being substantially less than the second length.

9. The inducer fan assembly according to claim 8, wherein the first length is less than the first diameter.

10. The inducer fan assembly according to claim 5, wherein the inlet member of the pipe elbow is off-set ninety degrees from the outlet member of the pipe elbow.

11. A pipe elbow comprising:
an inlet member having an inlet member centerline; and
an outlet member having an outlet member centerline, the inlet member centerline being off-set from the outlet member centerline.

12. The pipe elbow according to claim 11, wherein the inlet member includes a first diameter and the outlet member includes a second diameter.

13. The pipe elbow according to claim 12, wherein the first diameter is distinct from the second diameter.

14. The pipe elbow according to claim 12, further comprising:
a first length; and
a second length, the first length being substantially equal to the second length.

15. The pipe elbow according to claim 14, wherein the first length is less than the first diameter.

16. The pipe elbow according to claim 11, wherein the inlet member is off-set ninety degrees from the outlet member.

17. A gas furnace system comprising:
a heat exchanger;
an inducer fan assembly mounted to the heat exchanger, the inducer fan assembly having an inducer fan housing including a flue vent connection member configured and disposed to be connected to an exhaust gas flue vent, the flue vent connection member including a flue gas outlet and a flue vent condensate inlet; and
a pipe elbow mounted to the flue vent connection member, the pipe elbow including an inlet member having an inlet member centerline, and an outlet member having an outlet member centerline, the inlet member centerline being off-set from the outlet member centerline.

18. The gas furnace system according to claim 17, wherein the flue vent connection member extends axially outward from the inducer fan housing.

19. The gas furnace system according to claim 17, wherein the flue gas outlet is arranged concentrically relative to the flue vent condensate inlet.

20. The gas furnace system according to claim 19, wherein the flue gas outlet is arranged concentrically inward from the flue vent condensate inlet.

21. The gas furnace system according to claim 17, wherein the inlet member of the pipe elbow includes a first diameter and the outlet member of the pipe elbow includes a second diameter.

22. The gas furnace system according to claim 21, wherein the first diameter is distinct from the second diameter.

23. The gas furnace system according to claim 17, wherein the pipe elbow includes a first length and a second length, the first length being substantially equal to the second length, and wherein the first length is less than the first diameter.

24. The gas furnace system according to claim 17, wherein the inlet member of the pipe elbow is off-set ninety degrees from the outlet member of the pipe elbow.
